(19) United States
(12) Patent Application Publication
(10) Pub. No.: US 2008/0245521 A1
(43) Pub. Date: Oct. 9, 2008

(54) COOLING SYSTEM FOR AN ENCLOSURE

(76) Inventor: Rejean Lavergne, Quebec (CA)

Correspondence Address: NUTTER MCCLENNEN & FISH LLP, WORLD TRADE CENTER WEST, 155 SEAPORT BOULEVARD, BOSTON, MA, 02210-2604, US

(21) Appl. No.: 12/046,232

(22) Filed: Mar. 11, 2008

Related U.S. Application Data
(60) Provisional application No. 60/906,313, filed on Mar. 12, 2007.

(51) Int. Cl. G05D 23/00; F28D 15/00

(52) U.S. Cl. 165/288; 165/104.31

(57) ABSTRACT

Disclosed is a cooling system for cooling an enclosure. The system comprises a fluid inlet and a fluid outlet which are interconnected by a fluid pathway. A fluid mover is in fluid communication with the pathway and moves fluid along it. A programmed controller operates the fluid mover to direct fluid flow along the fluid pathway. The controller is programmed such that in response to a first fluid located outside the enclosure being detected at a first temperature that is equal to or less than a detected second temperature of a second fluid located inside the enclosure, the mover moves the first fluid into the enclosure thereby lowering the temperature inside the enclosure.

### CROSS REFERENCE TO RELATED APPLICATIONS

Applicant hereby claims priority from previously filed U.S. provisional patent application, Sere. No. 60/906,313, filed on Mar. 12, 2007.

### FIELD OF THE INVENTION

The present invention concerns a cooling system and more particularly to a cooling system for use with an enclosure.

### BACKGROUND OF THE INVENTION

Energy efficient cooling of enclosures such as rooms in houses or offices helps to maintain comfortable living and working environments. Generally speaking, enclosures are cooled using a heat pumps, compressors or standard air conditioning units. However such cooling devices can require high consumption of energy and thus can be expensive to operate. In countries where the outside temperature can be at or less than 4° C. for extended periods during the year, it might be possible to harness the difference in temperature between the inside of the enclosure and the outside, and use the temperature difference to efficiently cool the enclosure.

Thus, a system for harnessing such energy differences would be desirable and would serve as an alternative to currently used cooling systems.

### SUMMARY OF THE INVENTION

I have unexpectedly discovered that cold air which surrounds an enclosure can be exploited to cool the interior of the enclosure in an energy efficient manner without using heat pumps, compressors or conventional cooling systems. This is achieved, in one example, by a system of dampers and ventilators which are remotely activated and which can draw cooling air from the outside into the enclosure. In another example, a cooling medium, which has been cooled while located outside the enclosure, is moved into a warm room, whereupon it absorbs thermal energy from the room.

Accordingly, in one embodiment there is provided a cooling system for cooling an enclosure, the system comprising:
a) a fluid inlet;
b) a fluid outlet;
c) a fluid pathway interconnecting the inlet and the outlet;
d) a fluid mover in fluid communication with the fluid pathway for moving fluid along the fluid pathway; and
e) a programmed controller operably connected to the fluid mover for directing fluid flow along the fluid pathway, the controller being programmed such that in response to a first fluid located outside the enclosure being detected at a first temperature equal to or less than a detected second temperature of a second fluid located inside the enclosure, the fluid mover moves the first fluid into the enclosure thereby lowering the temperature inside the enclosure.

Typically, the system further comprises an inside damper and an outside damper for regulating fluid flow into and out of the enclosure, the fluid mover being located downstream of the inside damper. The fluid mover is a first ventilator in fluid communication with the inside damper. The first ventilator and the first damper are located inside the enclosure, and the second damper is located outside the enclosure. In one example, the first ventilator is a fan. The fluid inlet is an elongate channel mounted on an inner wall of the enclosure, one end of the channel being located to receive fluid from the fluid mover. First and second relays are connected to the ventilator. The fluid outlet is located away from the fluid inlet, the fluid outlet being located in an upper portion of the enclosure.

Alternatively, the fluid pathway includes a heat exchanger. The heat exchanger includes:
a) a first radiator located inside the enclosure;
b) a second radiator located outside the enclosure; and
c) a conduit fluidily interconnecting the radiators, the conduit having an amount of a cooling medium therein.

The fluid mover is located between the first and second radiators for moving the cooling medium along the conduit. In one example, the fluid mover is a fluid pump. Second and third ventilators are located adjacent the first and second radiators. In one example the second and third ventilators are fans.

In the system described above, an outside temperature sensor is located exterior the enclosure and an inside temperature sensor is located inside the enclosure, the temperature sensors being in communication with the fluid mover. The programmed controller is a control box located inside the enclosure. The first and second fluids are air, the first fluid being outside air at a temperature equal to or less than the air inside the enclosure.

### BRIEF DESCRIPTION OF THE DRAWINGS

Further aspects and advantages of the present invention will become better understood with reference to the description in association with the following Figures, wherein:

FIG. 1 is a diagrammatic representation of an embodiment of a cooling system for use in a room; and

FIG. 2 is a diagrammatic representation of an alternative embodiment of a cooling system for use in a room

### DETAILED DESCRIPTION OF THE INVENTION

### Definitions

Unless otherwise stated, the following terms apply:

The singular forms “a”, “an” and “the” include corresponding plural references unless the context clearly dictates otherwise.

As used herein, the term “comprising” is intended to mean that the list of elements following the word “comprising” are required or mandatory but that other elements are optional and may or may not be present.

As used herein, the term “consisting of” is intended to mean including and limited to whatever follows the phrase “consisting of”. Thus the phrase “consisting of” indicates that the listed elements are required or mandatory and that no other elements may be present.

As used herein, the term “fluid” is intended to mean either air or liquid.

As used herein, the term “cooling medium” is intended to mean a non-freezing ecologic liquid, such as, for example, salt water, glycol and the like.

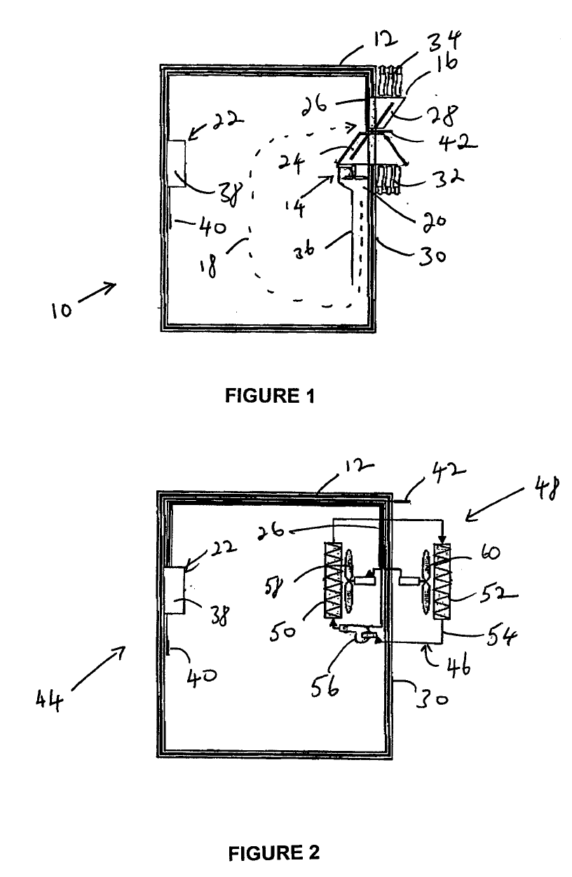

Referring now to FIG. 1, an embodiment of a cooling system is shown generally at 10. The system 10 is illustrated in use with a walled enclosure 12 such as a room in a house. It is to be understood that the cooling system can be installed into any walled enclosure for which internal cooling desired. Non-limiting examples of other walled enclosures include refrigerators, cooling counters and any other enclosure that is typically cooled using a heat pump, compressor or other such cooling system known to those in the art.

Broadly speaking, the system 10 comprises a fluid inlet 14, a fluid outlet 16, a fluid pathway 18 that interconnects the fluid inlet 14 and the fluid outlet 16, a fluid mover 20 in fluid communication with the fluid pathway 18 for moving fluid therealong, and a programmed controller 22 that is operably connected to the fluid mover 20 for directing fluid flow along the fluid pathway 18.

Still referring to FIG. 1, the system 10 further comprises an inside damper 24 that is mounted on an inside wall 26 of the enclosure 12. An outside damper 28 is mounted on an outside wall 30 of the enclosure 12. The dampers 24, 28 are spring-mounted and regulate fluid flow through the system by allowing one-way movement of the fluid therethrough. The dampers 24, 28 are generally mounted on an exterior facing wall of the enclosure. It is also possible that the dampers 24, 28 could be located elsewhere in the enclosure, however, such location would require additional air ducts. A first relay 32 is located near the inside damper 24 and a second relay 34 is located near the outside damper 28. Both relays 32, 34 are typically mounted on the outside wall of the enclosure and are in communication with the programmed controller 22 and the fluid mover 20.

The fluid inlet 14 is an elongate channel 36 that is mounted on an inside wall of the enclosure and may extend along the wall substantially parallel with the ground depending on the desired aesthetics. One end of the channel 36 is located to receive fluid from the fluid mover 20 and is typically located around the fluid mover 20. The fluid outlet 16 is located away from the fluid inlet 14 and is in communication with the outside damper 28. Typically, the fluid outlet 16 is located in an upper portion of the enclosure 12 and with the outside damper 28 compensates for fluid overpressure, as will be explained in more detail below. Thus, the outside damper 28 operates as a pressure control damper. The fluid outlet 16 is typically a vent or a grille.

It is to be understood that the fluid inlet 14 and the fluid outlet 16 can be part of the inside and outside dampers 24, 28 The fluid mover 20 is a ventilator, which is typically a fan, and which is in fluid communication with the inside damper 24 and controls fluid (air) movement into the enclosure 12 and along the fluid pathway 18.

The programmed controller 22 is located inside the enclosure 12 and may be mounted on the inside wall of the enclosure and housed within a box 38. The box 38 contains thermostats and relays (not shown) to control the system. The programmed controller 22 is typically located at a distance away from the dampers 24, 28 and the ventilator 20. An inside temperature sensor 40 is located inside the enclosure and is mounted on the inside wall 26 adjacent the programmed controller 22. The inside temperature sensor 40 is used to detect the temperature of the air inside the enclosure 12. An outside temperature sensor 42 is located outside the enclosure 12 and is mounted on the outside wall 30 of the enclosure 12. The outside temperature sensor 42 can be part of the dampers 24, 28 and projects away from the outside damper 28. The programmed controller 22 is in communication with the relays 32, 34 and the temperature sensors 40, 42 and controls the operation of the system 10 when its use is desired. The controller 22 receives signals from the temperature sensors 40, 42 and powers the ventilator 20.

Still referring to FIG. 1, in operation, the system 10 uses cool outside air to cool the inside of the enclosure 12. A user programs the controller 22 to a desired interior temperature, which is detected and monitored by the inside temperature sensor 40. The sensor 40 operates as a probe which communicates with the thermostat located inside the box 38. If an existing cooling system is in operation (not shown) the first relay 32 will deactivate it and activate the system 10 as follows. The controller 22 is programmed such that in response to a first fluid located outside the enclosure being detected at a first temperature, typically cool outside air at approximately 4° C. or less, that is equal to or less than a detected second temperature of a second fluid located inside the enclosure, typically air at ambient temperature or above, the ventilator 20 moves the first fluid into the enclosure 12 thereby lowering the temperature inside the enclosure 12. In the embodiment shown in FIG. 1, once the ventilator 20 draws air into the enclosure 12, an overpressure is created inside the enclosure 12. The overpressure pushes the warm air from the top of the enclosure 12 towards the air outlet 16, which opens and allows the warm air to exhaust out of the enclosure 12.

The first embodiment of the cooling system 10 is shown for use with an enclosure in which warm air inside the enclosure is replaced by cool air from outside the enclosure. A similar design of cooling system can be used when the air quality is important or in the case of a cooling counter, the contribution of the surrounding air is a problem, such as for example if the outside air is contaminated with car exhaust fumes and the like.

Referring now to FIG. 2, in which an alternative embodiment of the cooling system is shown generally at 44. The cooling system 44 can be used to cool the inside of the enclosure 12, and includes the two temperature sensors 40, 42, the programmed controller 22 and the control box 38 of the system 10. In this embodiment, however, a fluid pathway 46 includes a heat exchanger 48. The heat exchanger 48 includes a first radiator 50 that is located inside the enclosure 12 and a second radiator 52 that is located outside the enclosure 12. A conduit 54 which contains an amount of a cooling medium (not shown) fluidity interconnects the radiators 50, 52 to from a closed loop. The fluid mover is a fluid pump 56 which is located between the first and second radiators 50, 52 for moving the cooling medium along the conduit 54 and into the radiators 50, 52 thereby filling the fluid pathway 46 with the cooling medium, such as salt water, glycol and the like. Driven by the fluid pump 56, the cooling medium is fed into the radiators 50, 52 and typically crosses through the external facing wall 30 of the enclosure 12 at spaced apart locations.

An inside ventilator 58 is located between the inside radiator 50 and the inside wall 26 of the enclosure 12 and an outside ventilator 60 is located between the outside radiator 52 and the outside wall 30 of the enclosure 12. The ventilators 58, 60 are connected to each other through the enclosure wall. As with the system 10 described above, the ventilators 58, 60 are fans. The ventilators 58, 60 are in communication with the controller 22. A probe (or sensor) (not shown) is located inside the conduit 54 and is in contact with the cooling medium therein. If the cooling medium inside the conduit 54 drops to a temperature which is colder than required, the probe signals the controller to shut off the power to the ventilator 60. The pump 56 is connected to the conduit 54 and to the inside ventilator 58 and is typically located between the two radiators 50, 52.

The operation of the alternative system 44 is essentially identical to the system 10, with however some differences which will now be described. As described above, if an existing cooling system is in operation (not shown), a relay (not shown) located in the outside temperature sensor 42 will deactivate it and activate the system 44 as follows. The controller 22 is programmed such that in response to a first fluid located outside the enclosure 12 being detected at a first temperature, typically cool outside air at approximately 4° C. or less, that is equal to or less than a detected second temperature of a second fluid located inside the enclosure, typically air at ambient temperature or above, the pump 56 is activated such that cool cooling medium that is located in the outside radiator 52 and the portion of the conduit 54 located outside the enclosure 12 is drawn into the enclosure 12 and into the inside radiator 50. The controller 22 also activates the inside ventilator 58 which circulates the air inside the enclosure 12 until the desired temperature is achieved. The cooling medium located in the inside radiator 50 will absorb thermal energy from the circulating inside air and will thus heat up. The heated medium will return to the outside radiator 52 along the conduit 54 and is cooled by the outside ventilator. This cycle repeats until the desired temperature is achieved, thereafter, the pump will be deactivated.

### Other Embodiments

While specific embodiments have been described, those skilled in the art will recognize many alterations that could be made within the spirit of the invention, which is defined solely according to the following claims:

I claim:

1. A cooling system for cooling an enclosure, the system comprising:
a) a fluid inlet;
b) a fluid outlet;
c) a fluid pathway interconnecting the inlet and the outlet;
d) a fluid mover in fluid communication with the fluid pathway for moving fluid along the fluid pathway; and
e) a programmed controller operably connected to the fluid mover for directing fluid flow along the fluid pathway, the controller being programmed such that in response to a first fluid located outside the enclosure being detected at a first temperature equal to or less than a detected second temperature of a second fluid located inside the enclosure, the fluid mover moves the first fluid into the enclosure thereby lowering the temperature inside the enclosure.

2. The system, according to claim 1, further comprising an inside damper and an outside damper for regulating fluid flow into and out of the enclosure, the fluid mover being located downstream of the inside damper.

3. The system, according to claim 2, in which the fluid mover is a first ventilator in fluid communication with the inside damper.

4. The system, according to claim 3, in which the first ventilator and the first damper are located inside the enclosure, and the second damper is located outside the enclosure.

5. The system, according to claim 4, in which the first ventilator is a fan.

6. The system, according to claim 1, in which the fluid inlet is an elongate channel mounted on an inner wall of the enclosure, one end of the channel being located to receive fluid from the fluid mover.

7. The system, according to claim 3, in which first and second relays are connected to the ventilator.

8. The system, according to claim 1, in which the fluid outlet is located away from the fluid inlet, the fluid outlet being located in an upper portion of the enclosure.

9. The system, according to claim 1, in which the fluid pathway includes a heat exchanger.

10. The system, according to claim 9, in which the heat exchanger includes:
a) a first radiator located inside the enclosure;
b) a second radiator located outside the enclosure; and
c) a conduit fluidily interconnecting the radiators, the conduit having an amount of a cooling medium therein.

11. The system, according to claim 10, in which the fluid mover is located between the first and second radiators for moving the cooling medium along the conduit.

12. The system, according to claim 11, in which the fluid mover is a fluid pump.

13. The system, according to claim 10, in which second and third ventilators are located adjacent the first and second radiators.

14. The system, according to claim 13, in which the second and third ventilators are fans.

15. The system, according to claim 1, in which an outside temperature sensor is located exterior the enclosure and an inside temperature sensor is located inside the enclosure, the temperature sensors being in communication with the fluid mover.

16. The system, according to claim 1, in which the programmed controller is a control box located inside the enclosure.

17. The system, according to claim 1, in which the first and second fluids are air, the first fluid being outside air at a temperature equal to or less than the air inside the enclosure.
